(19) United States
(12) Patent Application Publication
(10) Pub. No.: US 2020/0234124 A1
(43) Pub. Date: Jul. 23, 2020

(54) WINOGRAD TRANSFORM CONVOLUTION OPERATIONS FOR NEURAL NETWORKS

(71) Applicant: Samsung Electronics Co., Ltd., Suwon-si (KR)

(72) Inventor: Jun-seok PARK, Hwaseong-si (KR)

(73) Assignee: Samsung Electronics Co., Ltd., Suwon-si (KR)

(21) Appl. No.: 16/747,076

(22) Filed: Jan. 20, 2020

(30) Foreign Application Priority Data
Jan. 23, 2019 (KR) 10-2019-0008603

(51) Int. Cl. G06N 3/08; G06N 20/10; G06F 17/14

(52) U.S. Cl. CPC G06N 3/08; G06F 17/144; G06N 20/10

(57) ABSTRACT

Some example embodiments may involve performing a convolution operation of a neural network based on a Winograd transform. Some example embodiments may involve a device including neural network processing circuitry that is configured to generate, by the neural network processing circuitry, a transformed input feature map by performing a Winograd transform on an input feature map, the transformed input feature map having a matrix form and including a plurality of channels; to perform, by the neural network processing circuitry, element-wise multiplications between a feature vector of the transformed input feature map and a weight vector of a transformed weight kernel obtained based on the Winograd transform; and to add, by the neural network processing circuitry, element-wise multiplication results, the element-wise multiplications being performed channel-by-channel with respect to the feature vector including feature values on a position in the plurality of channels of the transformed input feature map.

### CROSS-REFERENCE TO RELATED APPLICATION

This application claims the benefit of Korean Patent Application No. 10-2019-0008603, filed on Jan. 23, 2019, in the Korean Intellectual Property Office, the disclosure of which is incorporated herein in its entirety by reference.

### BACKGROUND

Some example embodiments of some inventive concepts may include methods, devices, and the like for performing neural network convolution operations. Some example embodiments may relate to methods, devices, and the like for performing a convolution operation of a neural network based on a Winograd transform.

A neural network refers to a computational architecture, which is a model of a biological brain. As neural network technology has recently been developed, there has been a lot of research into obtaining valid information from input data based on at least one neural network model in various kinds of electronic systems. In some circumstances, processing a convolution operation of a neural network may involve takes a significant number of operations. Therefore, neural network processing circuitry that is configured to perform a convolution operation of a neural network in an efficient manner may be advantageous.

### SUMMARY

Some example embodiments of some inventive concepts may include methods, devices, and the like that perform a convolution operation of a neural network based on a Winograd transform as disclosed herein. Some such example embodiments that involve a Winograd transform may exhibit increased efficiency and/or reduced power consumption in contrast with some other examples.

Some example embodiments of some inventive concepts may include a device for performing a convolution operation of a neural network, which may include neural network processing circuitry that is configured to generate a transformed input feature map by performing a Winograd transform on an input feature map, the transformed input feature map having a matrix form and including a plurality of channels; perform element-wise multiplications between a feature vector of the transformed input feature map and a weight vector of a transformed weight kernel obtained based on the Winograd transform and configured to add element-wise multiplication results, the element-wise multiplications being performed channel-by-channel with respect to the feature vector including feature values on a position in the plurality of channels of the transformed input feature map.

Some example embodiments of some inventive concepts may include a method of operating a device including neural network processing circuitry to perform a convolution operation of a neural network, wherein the method includes reformatting, by the neural network processing circuitry, at least one Winograd-transformed weight kernel into a plurality of weight beams by grouping weights in corresponding positions in a plurality of channels of the at least one Winograd-transformed weight kernel into each of the weight beams, obtaining a Winograd-transformed input feature map, performing, by the neural network processing circuitry, a dot product on each of a plurality of feature beams and a corresponding weight beam among the plurality of weight beams, each of the plurality of feature beams including feature values on a same position in the plurality of channels of the Winograd-transformed input feature map, generating, by the neural network processing circuitry, an output feature map by reverse reformatting dot product results based on respective positions of the plurality of weight beams, the dot product results being respectively calculated with respect to the plurality of weight beams, and performing, by the neural network processing circuitry, a Winograd reverse transform on the output feature map.

Some example embodiments of some inventive concepts may include a neural network device, the neural network device including neural network processing circuitry configured to perform a neural network operation, the neural network processing circuitry configured to perform a Winograd-based convolution operation by performing an element-wise dot product on a input feature map and weight kernels obtained via Winograd transform, respectively, and performing the element-wise dot product with respect to each feature beam including corresponding elements in a plurality of channels of the input feature map.

### BRIEF DESCRIPTION OF THE DRAWINGS

Some example embodiments of some inventive concepts may be more clearly understood from the following detailed description taken in conjunction with the accompanying drawings in which:

FIG. 1 illustrates a data processing system according to some example embodiments of some inventive concepts;

FIG. 2 illustrates the architecture of a convolution neural network as an example of a neural network architecture;

FIG. 3 is a conceptual diagram of a convolution operation based on a Winograd transform, according to some example embodiments of some inventive concepts;

FIG. 4 is a flowchart of a method of performing a convolution operation based on a Winograd transform, according to some example embodiments of some inventive concepts;

FIG. 5 is a diagram of an example of the method of FIG. 4;

FIG. 6 is a block diagram of neural network processing circuitry according to some example embodiments of some inventive concepts;

FIG. 7 is a diagram for explaining the operation of a computing circuit, according to some example embodiments of some inventive concepts;

FIG. 8 is a circuit diagram of a processing element according to some example embodiments of some inventive concepts;

FIGS. 9 through 11 are diagrams of examples of zero-skipping, according to some example embodiments of some inventive concepts;

FIGS. 12A and 12B are diagrams of information about input features having a non-zero value, according to some example embodiments of some inventive concepts;

FIG. 13 is a circuit diagram of a processing element according to some example embodiments of some inventive concepts;

FIG. 14 is a flowchart of a method of operating neural network processing circuitry, according to some example embodiments of some inventive concepts; and

FIG. 15 is a block diagram of an integrated circuit and an apparatus including the same, according to some example embodiments of some inventive concepts.

### DETAILED DESCRIPTION OF THE EMBODIMENTS

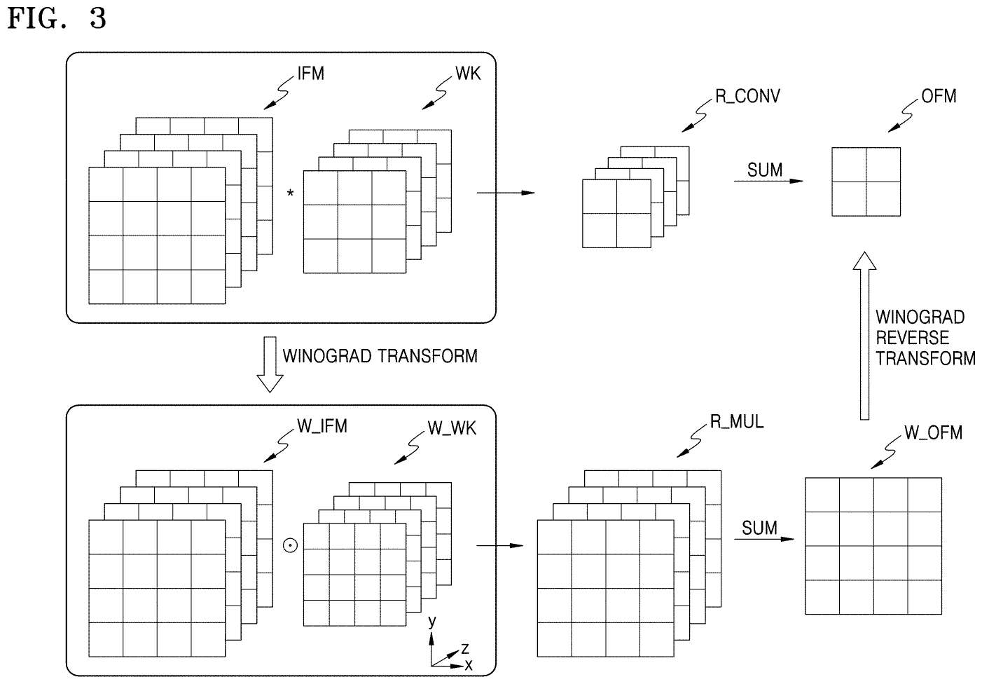

Some example embodiments involve processing a convolution operation in a neural network in a Winograd domain, for example, by applying a Winograd transform to each of an input feature map and a weight kernel, applying an element-wise multiplication and an element-wise addition, and applying a reverse Winograd transform to a sum of the addition to produce a convolution sum as an output of the convolution operation. Some example embodiments that utilize such processing may complete a convolution operation of a neural network with a reduced number of calculations as compared with direct convolution of the un-transformed input feature map and weight kernel, and such reduction may accelerate the completion of the neural network convolution operation and/or reduce the amount of power consumed by the completion of such operations, as will be shown, for example, with reference to FIG. 3. Some example embodiments include device architectures and/or neural network processing circuitry that may facilitate the processing of convolution operations of neural networks in such a manner. For example, in some example embodiments, a convolution operation of a neural network may be organized in such a manner as to reduce a number of vector multiplication sums, and, consequently, a reduced number of registers that are utilized by such neural network processing circuitry to perform the convolution operation.

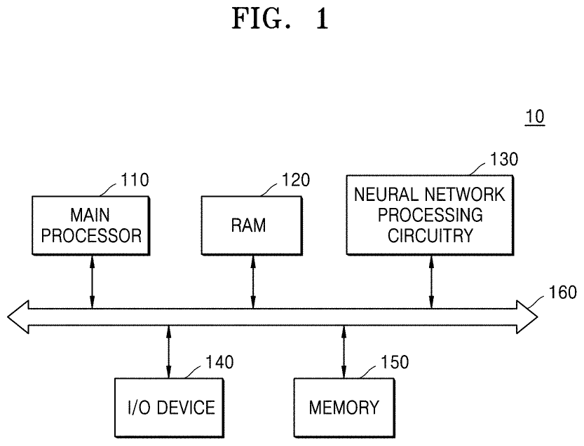

FIG. 1 illustrates a data processing system 10 according to some example embodiments of some inventive concepts. The data processing system 10 may analyze input data based on a neural network, obtain valid information, and identify a situation or control elements of an electronic device equipped with the data processing system 10 based on the valid information. For example, the data processing system 10 may be applied to a drone, an advanced driver assistance system (ADAS), a robot, a smart television (TV), a smart phone, a medical device, a mobile device, an image display, a measuring device, an Internet of Things (IoT) device, etc. The data processing system 10 may be mounted on any one of other various kinds of electronic devices.

In some example embodiments and as shown in FIG. 1, the data processing system 10 may include at least one intellectual property (IP) block and neural network processing circuitry 130. The data processing system 10 may include various kinds of IP blocks, for example, a main processor 110, random access memory (RAM) 120, an input/output (I/O) device 140, and memory 150, as shown in FIG. 1. The data processing system 10 may further include universal elements such as a multi-format codec, a video module (e.g., a camera interface, a Joint Photographic Experts Group (JPEG) processor, a video processor, or a mixer), a three-dimensional (3D) graphics core, an audio system, a display driver, a graphics processing unit (GPU), and a digital signal processor (DSP). Elements such as the main processor 110, the RAM 120, the neural network processing circuitry 130, the I/O device 140, and/or the memory 150, may be configured to transmit and/or receive data through a system bus 160. For example, as a standard bus protocol, an advanced microcontroller bus architecture (AMBA) protocol of Advanced RISC Machines (ARM) Ltd. may be applied to the system bus 160. As another example, the data processing system 10 may be implemented as a system-on-chip (SoC). However, some example embodiments are not limited thereto; for example, in some example embodiments, various kinds of IP blocks, elements, and/or protocols may be used.

In some example embodiments, some elements of the data processing system 10, such as the main processor 110, the RAM 120, the neural network processing circuitry 130, the I/O device 140, and/or the memory 150, may be implemented in a single semiconductor chip. However, some example embodiments are not limited thereto; for example, the data processing system 10 may be implemented in a plurality of semiconductor chips. In some example embodiments, the data processing system 10 may include an application processor mounted on a mobile device.

In some example embodiments, the main processor 110 may be configured to control some or all operations of the data processing system 10. For example, the main processor 110 may be implemented as a central processing unit (CPU). The main processor 110 may include a single core or multiple cores. The main processor 110 may be configured to process or execute programs and/or data, which are stored in the RAM 120 and/or the memory 150. For example, the main processor 110 may be configured to control functions of the data processing system 10 by executing programs stored in the memory 150.

In some example embodiments, the RAM 120 may be configured to store programs, data, and/or instructions temporarily. Programs and/or data stored in the memory 150 may be temporarily loaded to the RAM 120 according to the control of the main processor 110 or booting code. The RAM 120 may be implemented using memory such as dynamic RAM (DRAM) or static RAM (SRAM).

In some example embodiments, the I/O device 140 may be configured to receive user input and/or input data from outside the data processing system 10 and/or to output a data processing result of the data processing system 10. The I/O device 140 may be implemented as a touch screen panel, a keyboard, or any one of various kinds of sensors. In some example embodiments, the I/O device 140 may be configured to collect surrounding information of the data processing system 10. For example, the I/O device 140 may include at least one of various sensing devices, such as an image pickup device, an image sensor, a light detection and/or ranging (LIDAR) sensor, an ultrasonic sensor, and/or an infrared sensor, and/or may be configured to receive a sensing signal from the sensing devices. In some example embodiments, the I/O device 140 may be configured to sense and/or receive an image signal from outside the data processing system 10 and/or to convert the image signal into image data, for example, an image frame. The I/O device 140 may be configured to store the image frame in the memory 150 and/or to provide the image frame to the neural network processing circuitry 130.

In some example embodiments, the memory 150 may be configured as storage for storing data. For example, the memory 150 may be configured to store an operating system (OS), various programs, and/or various data. The memory 150 may include DRAM, but some example embodiments may not be limited thereto. The memory 150 may be volatile and/or non-volatile. Non-volatile memory may include at least one of read-only memory (ROM), programmable ROM (PROM), electrically programmable ROM (EPROM), electrically erasable programmable ROM (EEPROM), flash memory, phase-change RAM (PRAM), magnetic RAM (MRAM), resistive RAM (RRAM), and/or ferroelectric RAM (FeRAM). The volatile memory may include DRAM, SRAM, and/or synchronous DRAM (SDRAM). In some example embodiments, the memory 150 may include one or more storage devices, such as a hard disk drive (HDD), a solid-state drive (SSD), CompactFlash (CF) memory, Secure Digital (SD) memory, micro-SD memory, mini-SD memory, extreme digital (xD) memory, or a memory stick.

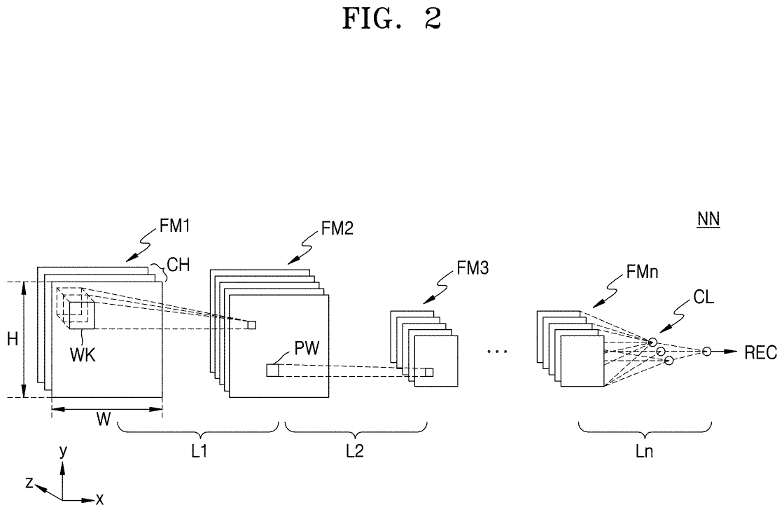

In some example embodiments, the neural network processing circuitry 130 may include hardware such as logic circuits; a hardware/software combination, such as a processor executing software; or a combination thereof. For example, a processor may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), and the like. The neural network processing circuitry 130 may be configured to generate a neural network, to train and/or to learn a neural network, to perform an operation based on input data, to generate an information signal based on an operation result, and/or to retrain a neural network. Such neural networks may include various neural network models, such as a convolutional neural network (CNN), a region with CNN (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, and/or a classification network, but some example embodiments are not limited thereto. In some example embodiments, the neural network processing circuitry 130 may include a plurality of processing elements that concurrently and/or simultaneously perform processing of the neural network, such as a set of processing elements that concurrently and/or simultaneously perform multiplication on several channels. In some example embodiments, the neural network processing circuitry 130 may be configured to process the neural network sequentially, such as a sequence of multiplication operations for each of several channels. An example of a neural network architecture will be described with reference to FIG. 2.

FIG. 2 illustrates the architecture of a convolution neural network as an example of a neural network architecture. A neural network NN may include a plurality of layers, for example, first through n-th layers L1 through Ln. The neural network NN may correspond to the architecture of a deep neural network (DNN) or an n-layer neural network. The plurality of layers may include a convolution layer, a pooling layer, an activation layer, and/or a fully-connected layer. For example, the first layer L1 may be a convolution layer, the second layer L2 may be a pooling layer, and the n-th layer Ln may be a fully-connected layer as an output layer. The neural network NN may also include an activation layer and may further include other layers performing other kinds of operations.

In some example embodiments and as shown in FIG. 2, each of the first through n-th layers L1 through Ln may be configured to receive input data (e.g., an image frame) and/or a feature map generated in a previous layer as an input feature map and/or to generate an output feature map or a recognition signal REC by performing an operation on the input feature map. The feature map refers to data which represents various features of input data. First through n-th feature maps FM1 through FMn may have a two-dimensional matrix form or a three-dimensional matrix (or a tensor) form. The first through n-th feature maps FM1 through FMn may include at least one channel CH having a matrix of feature values. When each of the first through n-th feature maps FM1 through FMn includes a plurality of channels CH, the channels CH have the same numbers of rows H and columns W as one another. In this case, a row H, a column W, and a channel CH may respectively correspond to the x-axis, the y-axis, and the z-axis in a coordinate system. A feature value at a certain row H and a certain column W of a two-dimensional matrix in the x-axis direction and the y-axis direction (hereinafter, a matrix refers to the two-dimensional matrix in the x-axis direction and the y-axis direction) may be referred to as an element of the matrix. For example, a 4×5 matrix may include 20 elements.

In some example embodiments, a first layer L1 may be configured to generate a second feature map FM2 by performing a convolution on a first feature map FM1 and a weight kernel WK. The weight kernel WK may be referred to as a filter or a weight map. The weight kernel WK may be included and/or configured to filter the first feature map FM1. The structure of the weight kernel WK may be similar to that of a feature map. The weight kernel WK may include at least one channel CH having a matrix of weights, and/or the number of channels CH included in the weight kernel WK may be the same as the number of channels CH included in a corresponding feature map, for example, the first feature map FM1. A convolution may be performed on the same channels in both the weight kernel WK and the first feature map FM1.

In some example embodiments, a weight kernel WK may be shifted on the first feature map FM1 using a sliding window method and/or may be convolved with windows (or referred to as tiles) of the first feature map FM1. During a shift, each weight included in the weight kernel WK may be multiplied by and/or added to all feature values in an area where the weight kernel WK overlaps the first feature map FM1. One channel of the second feature map FM2 may be generated by performing a convolution on the first feature map FM1 and/or the weight kernel WK. Although only one weight kernel WK is shown in FIG. 2, a plurality of weight kernels WK may be convolved with the first feature map FM1, thereby generating the second feature map FM2 including a plurality of channels.

In some example embodiments, a second layer L2 may be configured to generate the third feature map FM3, for example, by changing a spatial size of the second feature map FM2 through pooling. The pooling may be referred to as sampling or downsampling. A two-dimensional pooling window PW may be shifted on the second feature map FM2 by a unit of the size of the pooling window PW, and/or a maximum value may be selected among feature data (or an average of the feature data) in an area in which the pooling window PW overlaps the second feature map FM2. As such, the third feature map FM3 may be generated by changing the spatial size of the second feature map FM2. The number of channels of the third feature map FM3 may be the same as the number of channels of the second feature map FM2.

In some example embodiments, an n-th layer Ln may combine features of an n-th feature map FMn and/or categorize a class CL of the input data. The n-th layer Ln may also be configured to generate the recognition signal REC corresponding to the class CL. In some example embodiments, the input data may correspond to frame data included in a video stream. In this case, the n-th layer Ln may extract a class corresponding to an object depicted in an image represented by the frame data based on the n-th feature map FMn provided from a previous layer, to recognize the object, and/or to generate the recognition signal REC corresponding to the object.

Referring back to FIG. 1, the neural network processing circuitry 130 may include a hardware accelerator that is configured to perform operations according to neural network models. In some example embodiments, the hardware accelerator may be a dedicated module, for example, a neural processing unit (NPU), a tensor processing unit (TPU), or a neural engine, for driving a neural network, but is not limited thereto. The neural network processing circuitry 130 may be referred to herein as a neural network processing device or a neural network integrated circuit.

In some example embodiments, the neural network processing circuitry 130 may be configured to receive input data from at least one of other elements, such as the main processor 110, the I/O device 140, and/or the memory 150, optionally through the system bus 160 and/or to generate an information signal based on the input data. For example, the information signal generated by the neural network processing circuitry 130 may include at least one of various kinds of recognition signals, such as a voice recognition signal, an object recognition signal, an image recognition signal, and/or a biometric recognition signal. For example, the neural network processing circuitry 130 may be configured to receive frame data included in a video stream as input data and/or to generate a recognition signal with respect to an object, which may be included in an image represented by the frame data, from the frame data.

In some example embodiments, the neural network processing circuitry 130 may be configured to generate an information signal by performing a neural network operation on input data, such as a convolution operation. In a convolution-based neural network like a CNN, the convolution operation may take a significant portion of the neural network operation. The number of convolution operations may be based on various factors such as the number of channels of an input feature map, the number of channels of a weight kernel, the size of the input feature map, the size of the weight kernel, the precision of values, etc. As described with reference to FIG. 2, a neural network may have a complex architecture, and accordingly, the neural network processing circuitry 130 may be configured to perform a large number of convolution operations.

Some example embodiments may efficiently perform a convolution operation by performing convolution operations based on a Winograd transform, which may allow reduction in the number of multiplications involved in convolution operations.

In some example embodiments, the neural network processing circuitry 130 may be configured to perform a convolution operation by performing a Winograd transform on an input feature map and/or a plurality of weight kernels on a convolution layer and/or performing an element-wise multiplication on a transformed input feature map and/or a plurality of transformed weight kernels in a Winograd domain.

In some example embodiments, the neural network processing circuitry 130 may be configured to perform a dot product of a feature beam of the transformed input feature map and/or a weight beam of the transformed weight kernels. A dot product between the feature beam and/or the weight beam may be performed in parallel element-by-element. In this case, the feature beam may include feature values on a same position in a plurality of channels of the input feature map, that is, feature values of a certain element of matrices in a channel direction. The weight beam may include weights on a same position in a plurality of channels of the weight kernel, that is, weights of a certain element of matrices in the channel direction. The feature beam may be referred to as a feature channel vector and/or the weight beam may be referred to as a weight channel vector.

In some example embodiments, when performing an element-wise dot product on a feature beam of the transformed input feature map and/or a weight beam of the transformed weight kernels, the neural network processing circuitry 130 may be configured to multiply feature values sequentially by weights channel-by-channel and/or to perform addition. In other words, the neural network processing circuitry 130 may be configured to perform operations (for example, an element-wise multiplication and/or an element-wise addition) sequentially on the feature values and/or the weights in the channel direction. In this case, some example embodiments may include neural network processing circuitry 130 that may be configured to perform dot products with respect to a plurality of feature beams in parallel.

In some example embodiments, based on sequentially performing operations on feature values and/or weights in the channel direction, neural network processing circuitry 130 may be configured to skip an operation with respect to a channel in which at least one of a feature value and/or a weight has a zero value. In other words, zero-skipping may be used for a feature value or a weight during the operation of the neural network processing circuitry 130.

In some example embodiments, the neural network processing circuitry 130 may be configured to determine whether to use zero-skipping based on the proportion of feature values having the zero value in an input feature map or the proportion of weights having the zero value in weights kernels. For example, when the proportion of feature values having the zero value is lower than a certain reference value, zero-skipping may not be used.

As described above, according to some example embodiments, when a convolution operation based on a Winograd transform is performed in the data processing system 10, transformed weight kernels may be reformatted into weight beams in the channel direction according to the convolution operation based on a Winograd transform, and/or the neural network processing circuitry 130 may be configured to perform a dot product in units of beams (e.g., with respect to a feature beam and/or a weight beam). When performing the dot product, a value obtained by adding results of element-wise multiplications with respect to a plurality of channels may be stored in a register (e.g., an accumulation register) so that the capacity of the register may be reduced. Accordingly, in some example embodiments, the circuit size and/or power consumption of the neural network processing circuitry 130 may be reduced.

In addition, zero-skipping may be used during the multiplication and/or accumulation of a dot product, which may reduce the number of operations. In some example embodiments, in the case where a proportion of feature values having a zero value in an input feature map and/or a proportion of weights having a zero value in weights kernels are lower than the certain reference value, the power consumption of the neural network processing circuitry 130 may be reduced more when zero-skipping is not used than when zero-skipping is used. Accordingly, the neural network processing circuitry 130 may be configured to determine whether to use zero-skipping based on a proportion of feature values having a zero value in the input feature map and/or a proportion of weights having a zero value in the weights kernels. As a result, the performance of the data processing system 10 may be enhanced and/or the power consumption thereof may be reduced.

FIG. 3 is a conceptual diagram of a convolution operation based on a Winograd transform according to some example embodiments of some inventive concepts. Referring to FIG. 3, a Winograd transform may be performed on an input feature map IFM and/or a weight kernel WK to generate, respectively, a transformed input feature map W_{IFM} and/or a transformed weight kernel W_{WK} in a Winograd domain. In some various example embodiments, the Winograd transform may be performed by the neural network processing circuitry 130 and/or other IP blocks, such as a main processor 110, a GPU, and/or a DSP of a data processing system 10.

For example, in the case where the input feature map IFM includes four channels having a 4×4 matrix form and/or the weight kernel WK includes four channels having a 3×3 matrix form, the input feature map IFM and/or the weight kernel WK may be transformed by a Winograd transform to generate, respectively, the transformed input feature map W_{IFM} and/or the transformed weight kernel W_{WK}, each including four channels having a 4×4 matrix form. In other words, the size of the transformed input feature map W_{IFM} may be the same as the size of the transformed weight kernel W_{WK}.

In FIG. 3, an asterisk symbol (“*”) denotes a convolution operation, and a dotted circle symbol (“⊙”) denotes an element-wise multiplication. A convolution operation of the input feature map IFM and/or the weight kernel WK may be expressed as an element-wise multiplication of the transformed input feature map W_{IFM} and/or the transformed weight kernel W_{WK} in the Winograd domain.

When the convolution operation is performed on the input feature map IFM and/or the weight kernel WK, an operation result R_{CONV} having a 2×2 matrix form for each of the four channels may be output. An element-wise addition is performed on the operation result R_{CONV}, which may thereby generate an output feature map OFM having a 2×2 matrix form.

Based on an element-wise multiplication performed on the transformed input feature map W_{IFM} and/or the transformed weight kernel W_{WK} in the Winograd domain, an operation result R_{MUL} having a 4×4 matrix form for each of the four channels may be output. An element-wise addition is performed on the operation result R_{MUL} so that a transformed output feature map W_{OFM} having a 4×4 matrix form may be generated. Winograd reverse transform is performed on the transformed output feature map W_{OFM} so that the transformed output feature map W_{OFM} having a 4×4 matrix form may be transformed into the output feature map OFM having a 2×2 matrix form.

As described above, when an element-wise multiplication and/or an element-wise addition are performed on the transformed input feature map W_{IFM} and/or the transformed weight kernel W_{WK}, which are generated via Winograd transform, and/or the result of the element-wise addition undergoes Winograd reverse transform, an operation result that is the same as the result of performing a convolution operation on the input feature map IFM and/or the weight kernel WK, that is, the output feature map OFM, may be generated.

Some example embodiments may perform element-wise multiplication of the transformed input feature map W_{IFM} and/or the transformed weight kernel W_{WK} and/or a number of operations involved in Winograd transform and/or Winograd reverse transform, where a number of such multiplications may be less a number of multiplication operations involved in the non-Winograd convolution operation of the input feature map IFM and/or the weight kernel WK. Accordingly, in some example embodiments that include the neural network processing circuitry 130 configured to perform a convolution operation based on a Winograd transform, the number of operations and/or power consumption may be reduced.

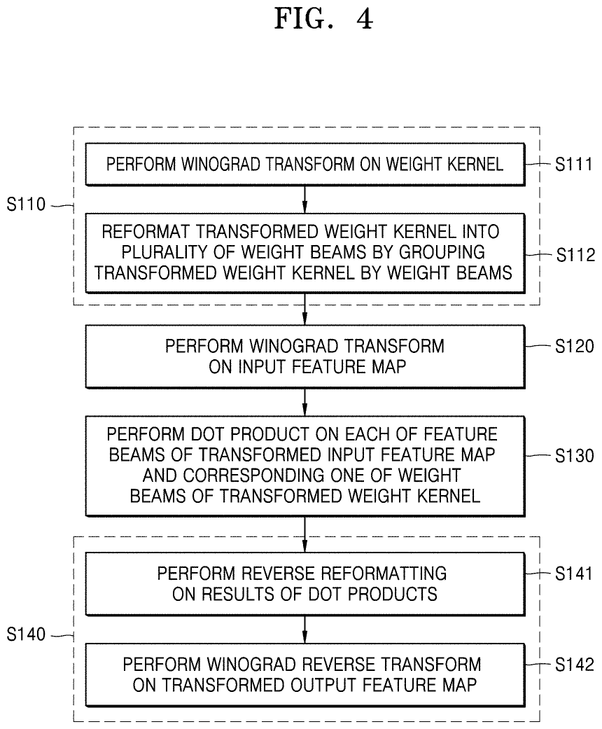

FIG. 4 is a flowchart of a method of performing a convolution operation based on a Winograd transform, according to some example embodiments of some inventive concepts.

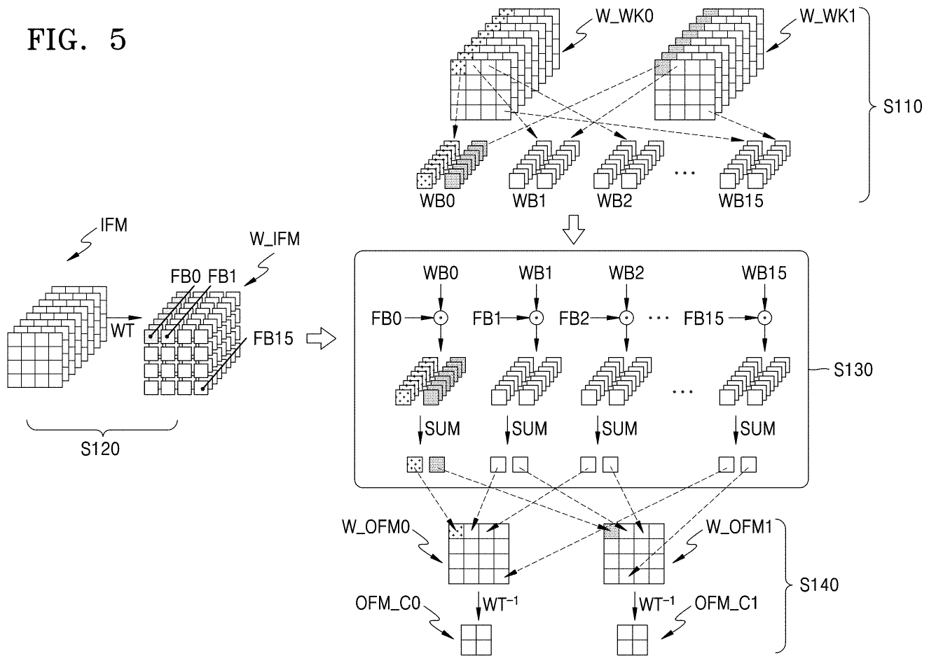

FIG. 5 is a diagram of an example of the method of FIG. 4. The method of FIGS. 4 and 5 may be performed in the data processing system 10 of FIG. 1.

Referring to FIGS. 4 and 5, in operation S110, a neural network processing circuitry (e.g., neural network processing circuitry 130 in FIG. 1) performs pre-processing on a weight kernel.

In operation S111, the neural network processing circuitry 130 performs Winograd transform on the weight kernel so as to generate a transformed weight kernel. For example, the neural network processing circuitry 130 may be configured to generate a first transformed weight kernel W_{WK0} and/or a second transformed weight kernel W_{WK1}. Although two transformed weight kernels, such as the first and/or second transformed weight kernels W_{WK0} and/or W_{WK1}, are illustrated in FIG. 5, some example embodiments of some inventive concepts may not be limited thereto; for example, in some example embodiments, at least one weight kernel may be transformed so that at least one transformed weight kernel may be generated. For example, each of the first transformed weight kernel W_{WK0} and/or the second transformed weight kernel W_{WK1} may include eight channels each having a 4×4 matrix form including 16 elements (e.g., pixels of a matrix of a channel).

In operation S112, the neural network processing circuitry 130 groups the transformed weight kernel by weight beams (or weight channel vectors) so as to reformat the transformed weight kernel into a plurality of weight beams. For example, when each of the first transformed weight kernel W_{WK0} and/or the second transformed weight kernel W_{WK1} includes 16 elements, as shown in FIG. 5, the neural network processing circuitry 130 may be configured to group the first transformed weight kernel W_{WK0} and/or the second transformed weight kernel W_{WK1} by weight beams so that the first transformed weight kernel W_{WK0} and/or the second transformed weight kernel W_{WK1} may be reformatted into first through sixteenth weight beams WB0 through WB15.

In some example embodiments, the pre-processing of the weight kernel in operation S110 may be performed before the input feature map IFM is received. In some example embodiments, during the pre-processing of the weight kernel, at least one of operations S111 and S112 may be performed by a different element from the neural network processing circuitry 130 in the data processing system 10 of FIG. 1, such as a main processor 110, and/or the neural network processing circuitry 130 may be configured to receive the result of the pre-processing. In some other example embodiments, all of operations S111 through S112 may be performed by the neural network processing circuitry 130.

In operation S120, when receiving input data, the neural network processing circuitry 130 performs a Winograd transform WT on an input feature map so as to generate a transformed input feature map. Referring to FIG. 5, the transformed input feature map W_{IFM} may have the same structure (e.g., the same number of channels and/or the same matrix size) as the first and/or second transformed weight kernels W_{WK0} and/or Www and/or may include, for example, first through sixteenth feature beams FB0 through FB15.

In operation S130, the neural network processing circuitry 130 may be configured to perform a dot product on each of the feature beams of the transformed input feature map and/or a corresponding one of the weight beams of the transformed weight kernel. For example, the neural network processing circuitry 130 may be configured to perform an element-wise multiplication on the transformed feature map and/or the transformed weight kernel not in units of channels but in units of feature beams. The neural network processing circuitry 130 may be configured to perform a dot product on the first feature beam FB0 and/or the first weight beam WB0 and/or perform a dot product on the second feature beam FB1 and/or the second weight beam WB1. In this way, the neural network processing circuitry 130 may be configured to perform a dot product on each of the first through sixteenth feature beams FB0 through FB15 and/or a corresponding one of the first through sixteenth feature beams FB0 through FB15. In some example embodiments, each result of a dot product operation may be stored in a register. For example, the results of dot products with respect to the first through sixteenth feature beams FB0 through FB15 may be stored in 32 registers, respectively. In some example embodiments, the results of dot products between the first through sixteenth feature beams FB0 through FB15 and the first through sixteenth weight beams WB0 through WB15 of the first transformed weight kernel W_{WK0} may be stored in 16 registers, respectively, and/or the results of dot products between the first through sixteenth feature beams FB0 through FB15 and the first through sixteenth weight beams WB0 through WB15 of the second transformed weight kernel W_{WK1} may be stored in another 16 registers, respectively.

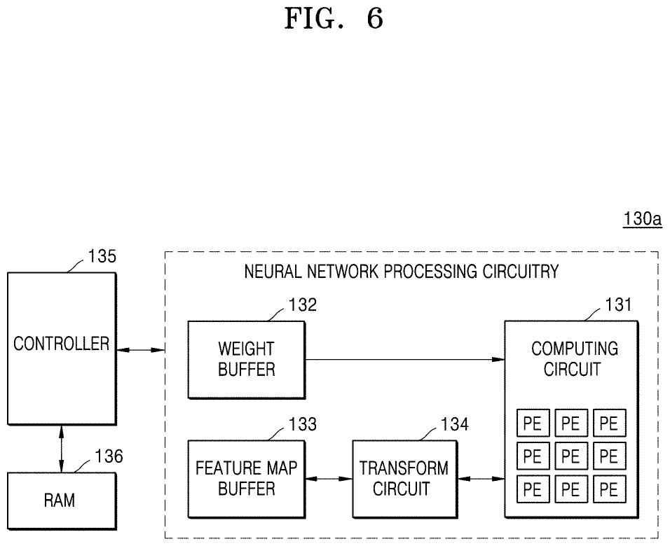

In some example embodiments, neural network processing circuitry 130 may be configured to perform dot products with respect to the first through sixteenth feature beams FB0 through FB15 in parallel. For example, neural network processing circuitry 130 may include a computing circuit 131 in FIG. 6, which includes a plurality of processing elements PE. The neural network processing circuitry 130 may perform a dot product on a feature beam and/or a weight beam, and/or the processing elements PE may respectively perform dot products in parallel.

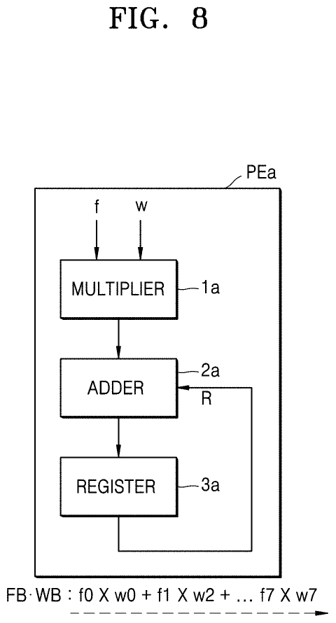

In some example embodiments, the neural network processing circuitry 130 may be configured to perform a multiplication and/or an addition sequentially on feature values of a feature beam and/or weights of a weight beam channel-by-channel (or element-by-element throughout channels). In some example embodiments, the neural network processing circuitry 130 may be configured to skip an operation with respect to a channel in which at least one of a feature value and/or a weight has the zero value. In other words, the neural network processing circuitry 130 may be configured to perform a dot product on a feature value and/or a weight, each having a non-zero value. The structure and/or operation of a processing element of the neural network processing circuitry 130 that uses zero-skipping will be described below with reference to FIGS. 8 through 11.

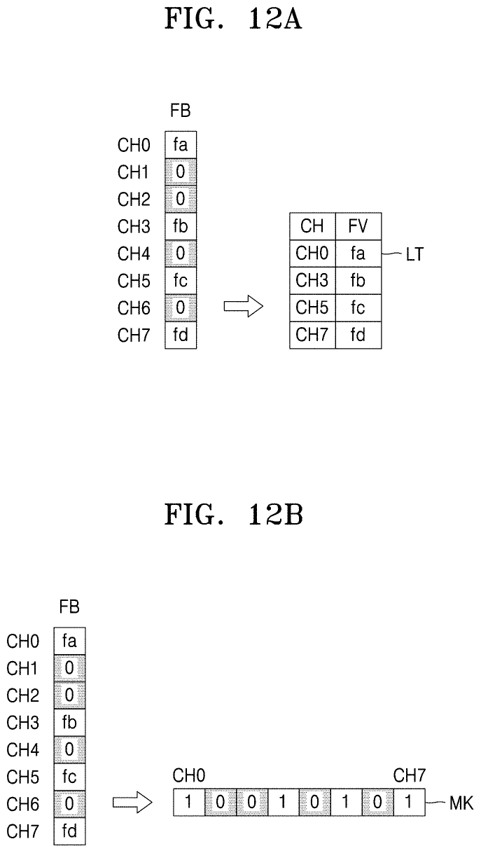

In some example embodiments, the neural network processing circuitry 130 may be configured to perform multiplications concurrently and/or simultaneously on feature values of a feature beam and/or weights of a weight beam channel-by-channel and/or then perform an addition on the multiplication results. The structure and/or operation of a processing element of the neural network processing circuitry 130 that is configured to perform multiplications concurrently and/or simultaneously channel-by-channel will be described below with reference to FIG. 13.

In operation S140, the neural network processing circuitry 130 performs reverse reformatting on the results of dot products so as to generate a transformed output feature map.

In operation S141, the neural network processing circuitry 130 performs reverse reformatting on the results of dot products, which are obtained with respect to the feature beams in operation S130, according to the position of each feature beam (or the position of each weight beam). Accordingly, channels of the transformed output feature map, for example, a first transformed output feature map W_{OFM0} and/or a second transformed output feature map W_{OFM1}, may be generated. In some example embodiments, the first transformed output feature map W_{OFM0} is an operation result based on the transformed input feature map W_{IFM} and/or the first transformed weight kernel W_{WK0}, and/or the second transformed output feature map W_{OFM1} is an operation result based on the transformed input feature map W_{IFM} and/or the second transformed weight kernel W_{WK1}. The first transformed output feature map W_{OFM0} and/or the second transformed output feature map W_{OFM1} may form different channels of the transformed output feature map.

In operation S142, the neural network processing circuitry 130 performs Winograd reverse transform WT⁻¹ on a transformed output feature map so as to generate an output feature map. The neural network processing circuitry 130 may be configured to generate a first output feature map OFM_{C0} and/or a second output feature map OFM_{C1}, each having a 2×2 matrix form, by performing the Winograd reverse transform WT⁻¹ on the first transformed output feature map W_{OFM0} and/or the second transformed output feature map W_{OFM1}, each having a 4×4 matrix form. The first output feature map OFM_{C0} and/or the second output feature map OFM_{C1} may form different channels of the output feature map.

A convolution operation based on a Winograd transform has been described with reference to FIGS. 4 and 5. As described above, according to some example embodiments, based on a convolution operation performed based on a Winograd transform, the neural network processing circuitry 130 may be configured to reformat a transformed weight kernel into a plurality of weight beams and/or to perform a dot product (for example, multiplication and/or addition) on a feature beam of a transformed input feature map and/or a weight beam of a transformed weight kernel. For example, the neural network processing circuitry 130 may be configured to perform a dot product with respect to each feature beam (or each weight beam).

Unlike example embodiments in which neural network processing circuitry 130 is configured to perform convolution operations based on a Winograd transform, processing that involves element-wise multiplication in units of channels and/or the addition of element-wise multiplication results with respect to each of a plurality of channels may involve storing the element-wise multiplication results of each channel. For example, when an element-wise multiplication is performed in units of channels with respect to the transformed input feature map W_{IFM} including eight channels having a 4×4 matrix form and/or the first and/or second transformed weight kernels W_{WK0} and/or W_{WK1} including eight channels having a 4×4 matrix form (for example, an element-wise multiplication performed on a first channel of the transformed input feature map W_{IFM} and/or a first channel of the first transformed weight kernel W_{WK0}) as shown in FIG. 5, sixteen element-wise multiplication results for each of the eight channels, that is, 128 element-wise multiplication results with respect to two transformed weight kernels, are stored.

By contrast, according to some example embodiments, since a dot product is performed in units of beams (e.g., with respect to a feature beam and/or a weight beam) in the channel direction in the convolution operation performed by neural network processing circuitry 130 based on a Winograd transform, the sum of multiplication results with respect to all channels may be stored in one register, and/or sixteen results with respect to each of two transformed weight kernels, that is, 32 results with respect to the two transformed weight kernels, may be stored in registers. Consequently, when an operation method is performed by neural network processing circuitry 130 that is configured according to an example embodiment, fewer registers are utilized, and/or the circuit size and/or power consumption of the neural network processing circuitry 130 may be reduced.

FIG. 6 is a block diagram of a neural network device according to some example embodiments of some inventive concepts. Neural network processing circuitry 130a of FIG. 6 may be applied to the data processing system 10 of FIG. 1.

In some example embodiments and as shown in FIG. 6, the neural network processing circuitry 130a may include a computing circuit 131, a weight buffer 132, a feature map buffer 133, a transform circuit 134, a controller 135, and/or RAM 136. Some or all of the elements of the neural network processing circuitry 130a, including the computing circuit 131, the weight buffer 132, the feature map buffer 133, the transform circuit 134, the controller 135, and/or the RAM 136, of the neural network processing circuitry 130a may be configured to communicate with one another through a system bus. In some example embodiments, neural network processing circuitry 130a may be implemented in a single semiconductor chip and/or may be implemented as, for example, an SoC but is not limited thereto. In some example embodiments, neural network processing circuitry 130a may be implemented in a plurality of semiconductor chips.

In some example embodiments and as shown in FIG. 6, the computing circuit 131 may include a plurality of processing elements PE and/or may perform the convolution operation, for example, element-wise multiplication and/or addition, based on a Winograd transform, as described with reference to FIGS. 4 and 5. The processing elements PE may be configured to perform a dot product on a feature beam and/or a weight beam. In some example embodiments, the weight buffer 132 may be configured to store weight kernels and/or to provide the weight kernels to the neural network processing circuitry 130a. The weight buffer 132 may include RAM, such as DRAM or SRAM. In some example embodiments, the weight buffer 132 may be configured to store weight kernels that have undergone pre-processing, such as in operation S110 in FIG. 4. For example, the weight buffer 132 may be configured to store weight kernels transformed based on a Winograd transform and/or to store weight beams into which the transformed weight kernels are reformatted.

In some example embodiments, a feature map buffer 133 may be configured to store input feature maps or output feature maps. The feature map buffer 133 may include RAM. In some example embodiments, the feature map buffer 133 may be a general matrix multiplication (GEMM)-based feature map buffer.

The feature map buffer 133 may be configured to provide input feature maps to the transform circuit 134 or to the computing circuit 131. For example, the feature map buffer 133 may be configured to provide input feature maps that are utilized in a Winograd-based convolution, to the transform circuit 134 and/or input feature maps, which are not utilized in a Winograd transform, to the computing circuit 131. For example, operations not involving a Winograd transform may include a 1×1 convolution when a weight kernel has a 1×1 matrix form, an operation of a fully-connected layer, and so on. In addition, the feature map buffer 133 may be configured to receive output feature maps from the computing circuit 131 and/or the transform circuit 134 and/or to store the output feature maps.

The transform circuit 134 may be configured to perform a Winograd transform or Winograd reverse transform. The transform circuit 134 may be implemented as a hardware logic including a multiplier and/or a subtractor. The transform circuit 134 may be configured to perform a Winograd transform on an input feature map and/or to provide a transformed input feature map to the computing circuit 131. In addition, the transform circuit 134 may be configured to receive operation results, such as dot product results, from the computing circuit 131; to generate an output feature map by performing reverse reformatting on the operation results; and/or to perform a Winograd reverse transform on the output feature map. For example, the transform circuit 134 may be configured to generate a transformed output feature map, that is, an output feature map in a Winograd domain, by performing reverse reformatting on the results of dot products, which may be performed with respect to feature beams, according to the position of each feature beam (or the position of each weight beam), as in operation S140 described with reference to FIGS. 4 and 5. The transform circuit 134 may be configured to generate an output feature map in the time domain by performing a Winograd reverse transform on the transformed output feature map.

In some example embodiments, a controller 135 may be configured to control all operations of neural network processing circuitry 130a. For example, the controller 135 may be configured to control the operations of the computing circuit 131, the weight buffer 132, the feature map buffer 133, and/or the transform circuit 134. For example, the controller 135 may be configured to set and/or manage parameters involved in a neural network operation, for example, a Winograd-based convolution operation, so that the computing circuit 131 may perform processing of one or more layers of a neural network.

In some example embodiments, the controller 135 may be configured to perform pre-processing on weight kernels. For example, the controller 135 may be configured to reformat weight kernels transformed based on a Winograd transform into weight beams and/or to store the weight beams in the weight buffer 132.

In some example embodiments, the controller 135 may be configured to generate information about input features having a non-zero value in an input feature map; to generate information about input features having a non-zero value and/or information about weights having a non-zero value in each weight kernel and/or to provide the information to the computing circuit 131. Accordingly, when performing a dot product, each of the processing elements PE of the computing circuit 131 may be configured to perform a multiplication with respect to an input feature having a non-zero value and/or to multiply an input feature having a non-zero value by a weight having a non-zero value. In other words, when the processing elements PE perform a dot product, zero-skipping may be used based on the information about input features having a non-zero value and/or the information about weights having a non-zero value.

In some example embodiments, information about input features having a non-zero value may include a non-zero feature list, which includes a non-zero feature value and/or a channel having the non-zero feature value (e.g., a position of the non-zero feature value on a input feature beam) with respect to each input feature beam. The controller 135 may be configured to generate the input features of each input feature beam for each of the input feature beams and/or to provide the information for a input feature beam to a processing element PE that performs the dot product on the input feature beam. In some example embodiments, the information about input features having a non-zero value may include a zero feature mask (or vector) in which a channel having the zero value is expressed as “0” and/or a channel having a non-zero value is expressed as “1” with respect to each input feature beam. The information about weights having a non-zero value may include a non-zero weight list similar to the non-zero feature list described above or a zero weight mask similar to the zero feature mask described above.

In some example embodiments, the controller 135 may be configured to calculate a proportion of feature values having a non-zero value in a transformed input feature map and/or a proportion of weights having a non-zero value in a transformed weight kernel, and/or may be configured to determine whether to use zero-skipping during a dot product based on the calculated proportion(s).

In some example embodiments, the controller 135 may be implemented by hardware, software (or firmware), or a combination of hardware and software. In some example embodiments, the controller 135 may be implemented as a hardware logic designed to perform the above-described functions. In some example embodiments, the controller 135 may include at least one processor, such as a CPU or a microprocessor, and/or may be configured to execute a program loaded to the RAM 136. The program may include instructions that configure some or all of the functions described herein.

The RAM 136 may include DRAM or SRAM. The RAM 136 may store various kinds of programs and/or data for the controller 135 and/or store data generated in the controller 135.

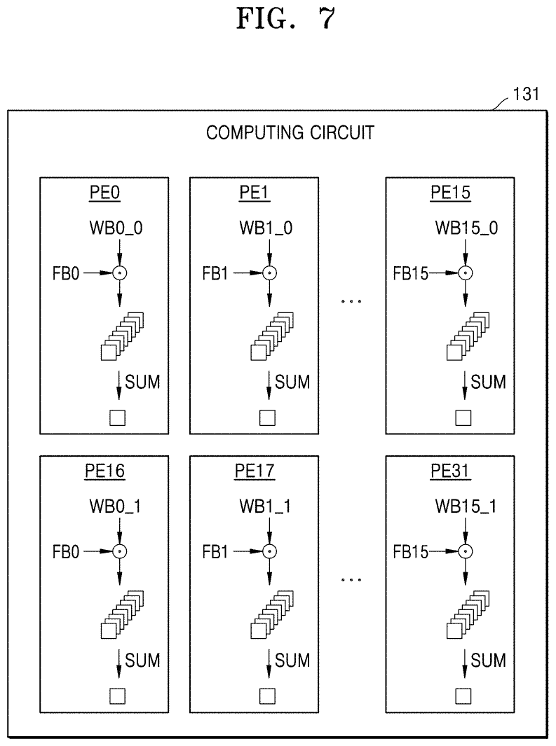

FIG. 7 is a diagram for explaining the operation of the computing circuit 131, according to some example embodiments of some inventive concepts. The operation of the computing circuit 131 of FIG. 7 will be described with reference to FIGS. 5 and 7.

Referring to FIG. 7, the computing circuit 131 may include a plurality of processing elements, for example, first through 32nd processing elements PE0 through PE31. Each of the first through 32nd processing elements PE0 through PE31 may be configured to perform a dot product on a feature beam and/or a weight beam. In this example and as described above with reference to FIG. 5, each of the transformed input feature map W_{IFM} and/or the first and/or second transformed weight kernels W_{WK0} and/or W_{WK1} may include sixteen beams (such as the first through sixteenth feature beams FB0 through FB15 or the first through sixteenth weight beams WB0 through WB15). Dot products between the first through sixteenth feature beams FB0 through FB15 and the first through sixteenth weight beams WB0 through WB15 of each of the first and/or second transformed weight kernels W_{WK0} and/or W_{WK1} may be performed by the first through 32nd processing elements PE0 through PE31. For example, the first processing element PE0 may be configured to perform a dot product on the first feature beam FB0 and/or a first weight beam WB0₀ of the first transformed weight kernel W_{WK0}. In other words, the first processing element PE0 may be configured to perform multiplications sequentially and/or channel-by-channel on the first feature beam FB0 and/or the first weight beam WB0₀ of the first transformed weight kernel W_{WK0} and/or to add the multiplication results. The second processing element PE1 may perform a dot product on the second feature beam FB1 and/or a second weight beam WB1₀ of the first transformed weight kernel W_{WK0}.

As shown in FIG. 7, the first through sixteenth processing elements PE0 through PE15 may be configured to perform, respectively, dot products with respect to first through sixteenth weight beams WB0₀ through WB15₀ of the first transformed weight kernel W_{WK0}. Similarly, seventeenth through 32nd processing elements PE16 through PE31 may be configured to perform, respectively, dot products with respect to first through sixteenth weight beams WB0₁ through WB15₁ of the second transformed weight kernel W_{WK1}. However, some example inventive concepts may not be limited thereto. For example, in some example embodiments, a first through sixteenth processing elements PE0 through PE15 may be configured to perform, respectively, dot products with respect to the first through sixteenth weight beams WB0₀ through WB15₀ of the first transformed weight kernel W_{WK0} and/or to perform, respectively, dot products with respect to the first through sixteenth weight beams WB0₁ through WB15₁ of the second transformed weight kernel W_{WK1}.

In some example embodiments, the first through 32nd processing elements PE0 through PE31 may be configured to operate independently from one another and/or to perform each dot product concurrently and/or simultaneously with others of the other processing elements, such that dot products with respect to the first through sixteenth feature beams FB0 through FB15 may be performed in parallel. In some example embodiments, dot products with respect to the first through sixteenth weight beams WB0₀ through WB15₀ of the first transformed weight kernel W_{WK0} and/or dot products with respect to the first through sixteenth weight beams WB0₁ through WB15₁ of the second transformed weight kernel W_{WK1} may be performed in parallel.

FIG. 8 is a circuit diagram of a processing element PEa according to some example embodiments of some inventive concepts. Referring to FIG. 8, the processing element PEa may include a multiplier 1a, an adder 2a, and/or a register 3a. The multiplier 1a may be configured to multiply a feature value “f” by a weight “w”. The adder 2a may be configured to add a multiplication result to a value R stored in the register 3a and/or to store an addition result in the register 3a. On condition that a feature beam FB includes first through eighth feature values f0 through f7, which correspond, respectively, to first through eight channels, and/or on condition that a weight beam WB includes first through eighth weights w0 through w7 respectively corresponding to the first through eight channels, the first through eighth feature values f0 through f7 may be sequentially provided to the multiplier 1a and/or the first through eighth weights w0 through w7 may be sequentially provided to the multiplier 1a so that a dot product, such as a channel-wise multiplication and/or a channel-wise addition, may be performed sequentially on the feature beam FB and/or the weight beam WB.

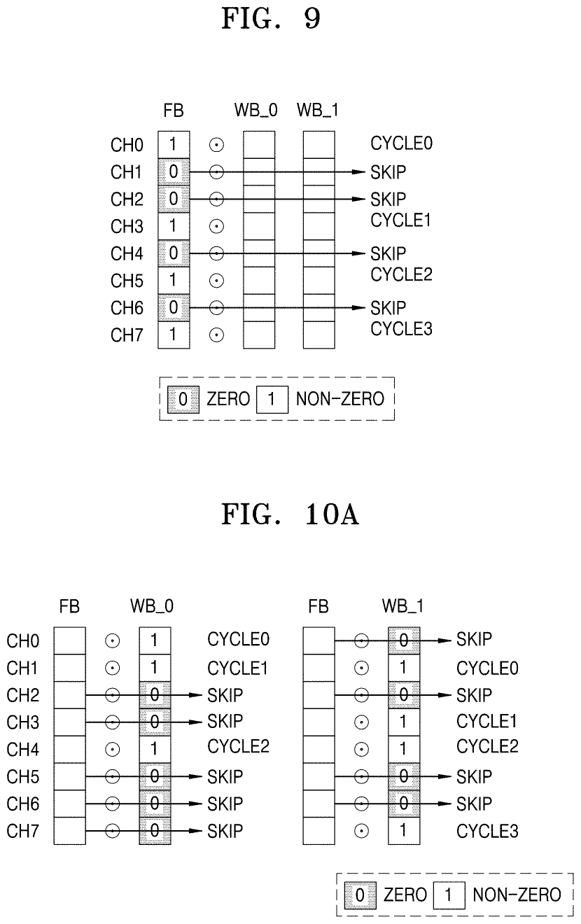

FIGS. 9 through 11 are diagrams of examples of zero-skipping, according to some example embodiments of some inventive concepts. The zero-skipping may be used when a dot product is performed by the processing element PEa of FIG. 8.

In some example embodiments and as shown in FIG. 9, zero-skipping may be used based on feature values of the feature beam FB. In some cases, some feature values of the feature beam FB may have a zero value, and/or other feature values thereof may have a non-zero value. For example, respective feature values of a first channel CH0, a fourth channel CH3, a sixth channel CH5, and/or an eighth channel CH7 may have a non-zero value, and/or respective feature values of a second channel CH1, a third channel CH2, a fifth channel CH4, and/or a seventh channel CH6 may have a zero value. A dot product with respect to the weight beam WB0 of a first transformed weight kernel and/or a dot product with respect to the weight beam WB₁ of a second transformed weight kernel may be performed, respectively, by two processing elements PEa in parallel or by a single processing element PEa in series. Each processing element PEa may be configured to perform a channel-wise multiplication and/or a channel-wise addition sequentially based on a clock signal. According to some example embodiments, the processing element PEa may be configured to perform a channel-wise multiplication based on the feature values that have a non-zero value and/or to skip the channel-wise multiplication with respect to the feature values that have a zero value. Accordingly, as shown in FIG. 9, the channel-wise multiplication may be skipped with respect to the zero feature values of the second, third, fifth, and/or seventh channels CH1, CH2, CH4, and/or CH6, and/or channel-wise multiplications with respect to non-zero feature values of the first, fourth, sixth, and/or eighth channels CH0, CH3, CH5, and/or CH7 may be sequentially performed during first through fourth cycles CYCLE0 through CYCLE3, respectively.

Referring to FIGS. 10A and 10B, zero-skipping may be used based on weights of the weight beams WB₀ and/or WB₁. Some weights of the weight beams WB₀ and/or WB₁ may have a zero value, and/or other weights thereof may have a non-zero value. For example, in the weight beam WB₀ of the first transformed weight kernel, respective weights of the first channel CH0, the second channel CH1, and/or the fifth channel CH4 may have a non-zero value, and/or respective weights of the third channel CH2, the fourth channel CH3, the sixth channel CH5, the seventh channel CH6, and/or the eighth channel CH7 may have a zero value. In the weight beam WB₁ of the second transformed weight kernel, respective weights of the second channel CH1, the fourth channel CH3, the fifth channel CH4, and/or the eighth channel CH7 may have a non-zero value, and/or respective weights of the first channel CH0, the third channel CH2, the sixth channel CH5, and/or the seventh channel CH6 may have a zero value. The processing element PEa may be configured to perform a channel-wise multiplication based on the weights that have a non-zero value and/or to skip the channel-wise multiplication with respect to the weights that have a zero value.

Referring to FIG. 10A, when a dot product is performed with respect to the weight beam WB₀ of the first transformed weight kernel, a channel-wise multiplication may be skipped with respect to the zero weights of the third, fourth, sixth, seventh, and/or eighth channels CH2, CH3, CH5, CH6, and/or CH7, and/or channel-wise multiplications with respect to non-zero weights of the first, second, and/or fifth channels CH0, CH1, and/or CH4 may be sequentially performed during the first through third cycles CYCLE0 through CYCLE2, respectively. When a dot product is performed with respect to the weight beam WB1 of the second transformed weight kernel, a channel-wise multiplication may be skipped with respect to the zero weights of the first, third, sixth, and/or seventh channels CH0, CH2, CH5, and/or CH6, and/or channel-wise multiplications with respect to non-zero weights of the second, fourth, fifth, and/or eighth channels CH1, CH3, CH4, and/or CH7 may be sequentially performed during the first through fourth cycles CYCLE0 through CYCLE3, respectively.

Referring to FIG. 10B, a channel-wise multiplication may be skipped with respect to the zero weights in both the weight beam WB₀ of the first transformed weight kernel and the weight beam WB1 of the second transformed weight kernel. Accordingly, a channel-wise multiplication may be skipped with respect to the third, sixth, and/or seventh channels CH2, CH5, and/or CH6, and/or channel-wise multiplications may be sequentially performed with respect to the first, second, fourth, fifth, and/or eighth channels CH0, CH1, CH3, CH4, and/or CH7 during first through fourth cycles CYCLE0 through CYCLE4, respectively.

Referring to FIG. 11, zero-skipping may be used based on the feature values of the feature beam FB and/or the weights of the weight beams WB₀ and/or WB₁. For example, the respective feature values of the first, fourth, sixth, and/or eighth channels CH0, CH3, CH5, and/or CH7 may have a non-zero value, and/or the respective feature values of the second, third, fifth, and/or seventh channels CH1, CH2, CH4, and/or CH6 may have a zero value. In the weight beam WB₀ of the first transformed weight kernel, the respective weights of the first, second, and/or fifth channels CH0, CH1, and/or CH4 may have a non-zero value, and/or the respective weights of the third, fourth, sixth, seventh, and/or eighth channels CH2, CH3, CH5, CH6, and/or CH7 may have a zero value. In the weight beam WB₁ of the second transformed weight kernel, the respective weights of the second, fourth, fifth, and/or eighth channels CH1, CH3, CH4, and/or CH7 may have a non-zero value, and/or the respective weights of the first, third, sixth, and/or seventh channels CH0, CH2, CH5, and/or CH6 may have a zero value. Accordingly, the processing element PEa may be configured to skip a channel-wise multiplication with respect to the second, third, fifth, and/or seventh channels CH1, CH2, CH4, and/or CH6. The processing element PEa may also be configured to skip a channel-wise multiplication with respect to the sixth channel CH5 having a zero weight in both the weight beam WB₀ of the first transformed weight kernel and the weight beam WB₁ of the second transformed weight kernel. Accordingly, channel-wise multiplications may be respectively performed with respect to the first, fourth, and/or eighth channels CH0, CH3, and/or CH7 during the first through third cycles CYCLE0 through CYCLE2, respectively.

In some example embodiments and as shown in FIGS. 9 through 11, the processing element PEa may be configured to receive information (e.g., a non-zero feature list or a zero feature mask) about input features having a non-zero value among the feature values of the feature beam FB and/or information about weights having a non-zero value among the weights of the weight beams WB₀ and/or WB₁, and/or may be configured to perform channel-wise multiplications based on the feature values having a non-zero value and/or the weights having a non-zero value based on the received information. In some example embodiments, the processing element PEa may be configured to receive the information about input features having a non-zero value and/or the information about weights having a non-zero value from the controller 135 in FIG. 6.

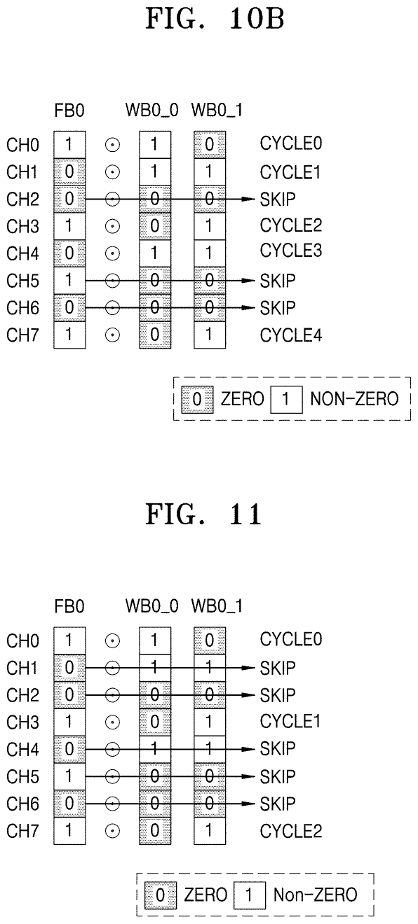

FIGS. 12A and 12B are diagrams of information about input features having a non-zero value, according to some example embodiments of some inventive concepts. Referring to FIG. 12A, the information about input features having a non-zero value may include a non-zero feature list LT. The non-zero feature list LT may include channels CH, for example, the first channel CH0, the fourth channel CH3, the sixth channel CH5, and/or the eighth channel CH7, having a non-zero feature value in the feature beam FB and/or non-zero feature values FV, for example, a first feature value fa, a fourth feature value fb, a sixth feature value fc, and/or an eighth feature value fd, corresponding to the channels CH.

Referring to FIG. 12B, the information about input features having a non-zero value may include a weighted feature mask MK. The weighted feature mask MK may include a value indicating whether each channel of the feature beam FB has a non-zero feature value or a zero feature value. For example, a channel having a zero value may be expressed as “0” and/or a channel having a non-zero value may be expressed as “1”.

At this time, the processing element PEa may be configured to receive information (e.g., a non-zero feature list or a non-zero feature mask) about input features having a non-zero value among the feature values of the feature beam FB. Based on the information, the processing element PEa may be configured to perform channel-wise multiplications based on the feature values having a non-zero value and/or to skip a channel-wise multiplication with respect to feature values having a zero value, based on the received information. For example, the processing element PEa may be configured to receive the information about input features having a non-zero value from the controller 135 in FIG. 6.

FIG. 13 is a circuit diagram of a processing element PEb according to some example embodiments of some inventive concepts. Referring to FIG. 13, the processing element PEb may include a plurality of multipliers 1b₁ through 1b₄, an adder 2b, and/or a register 3b. The multipliers 1b₁ through 1b₄ may be configured to perform multiplication, respectively, on feature values f0 through f3 by weights w0 through w3. The adder 2b may be configured to add multiplication results received, respectively, from the multipliers 1b₁ through 1b₄ and/or to store an addition result in the register 3b. Although the processing element PEb includes four multipliers 1b₁ through 1b₄ in FIG. 13, some example inventive concept of some example embodiments may not be limited thereto. For example, in some example embodiments, a number of multipliers may be changed.

In some example embodiments, when the number of multipliers 1b₁ through 1b₄ is less than the number of channels of a feature beam with respect to which the processing element PEb performs a dot product, a multiplication of each of the multipliers 1b₁ through 1b₄ and/or an addition of the adder 2b may be repeated multiple times. The adder 2b may be configured to add multiplication results and/or add multiplication results to a previous addition result R stored in the register 3b, and/or to store an addition result in the register 3b. For example, when the processing element PEb includes four multipliers 1b₁ through 1b₄ and/or a feature beam includes eight channels, the four multipliers 1b₁ through 1b₄ may be configured to receive and/or perform channel-wise multiplications on feature values and/or weights of, respectively, first though fourth channels in a first cycle. The adder 2b may be configured to add values respectively received from the four multipliers 1b₁ through 1b₄ and/or store an addition result in the register 3b. Thereafter, the four multipliers 1b₁ through 1b₄ may be configured to receive and/or perform channel-wise multiplications on feature values and/or weights of, respectively, fifth through eighth channels in a second cycle. The adder 2b may be configured to add values respectively received from the four multipliers 1b₁ through 1b₄ and/or add values respectively received from the four multipliers 1b₁ through 1b₄ to the previous addition result R stored in the register 3b, and/or to store an addition result in the register 3b.

In some example embodiments, the structure of the processing element PEb of FIG. 13 and/or the structure of the processing element PEa of FIG. 8 may be applied to a computing circuit, for example, the processing elements PE of the computing circuit 131 in FIG. 6. In other words, some of the processing elements PE of the computing circuit 131 in FIG. 6 may have the structure of the processing element PEa of FIG. 8, and/or others may have the structure of the processing element PEb of FIG. 13.

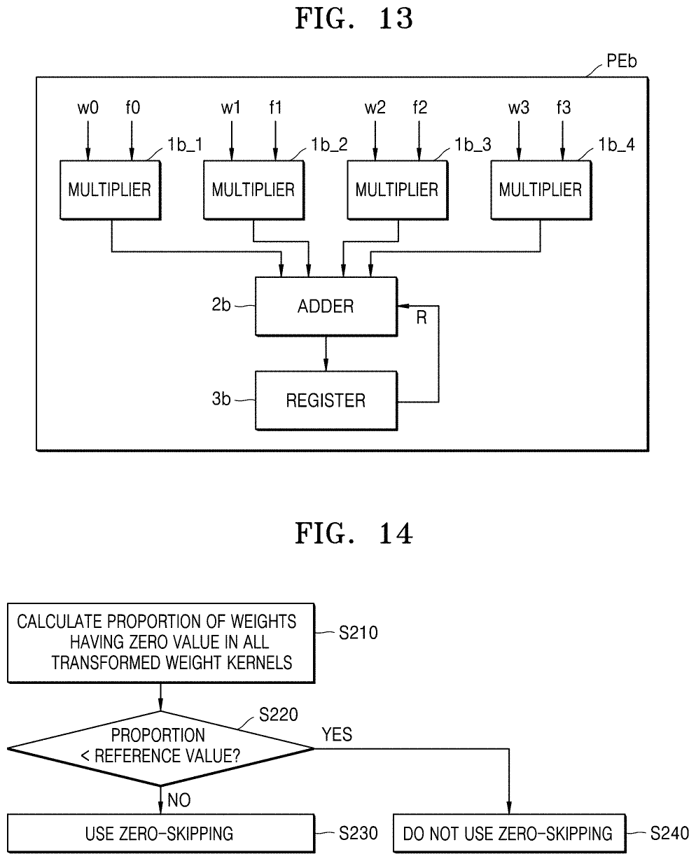

FIG. 14 is a flowchart of a method of operating neural network processing circuitry, according to some example embodiments of some inventive concepts. In some example embodiments, the method of FIG. 14 may be performed by neural network processing circuitry 130a.

Referring to FIG. 14, in operation S210, neural network processing circuitry 130a may calculate the proportion of weights having a zero value in a transformed weight kernel. For example, a controller 135 may be configured to calculate the ratio of the number of weights having a zero value to the number of all weights of the transformed weight kernels stored in the weight buffer 132.

In some example embodiments, neural network processing circuitry 130a may be configured to determine whether the calculated proportion is less than a reference value in operation S220. For example, a reference value may be identified (for example, preset) based on the number of processing elements PE included in the computing circuit 131, a circuit size, and so on.

In some example embodiments, when a proportion is not less than a reference value, that is, when the proportion is equal to or greater than the reference value, neural network processing circuitry 130a may be configured to determine to use zero-skipping during a dot product of a feature beam and/or a weight beam in operation S230. However, when the proportion is less than the reference value, the neural network processing circuitry 130a may be configured to determine not to use zero-skipping during a dot product of a feature beam and/or a weight beam in operation S240.

In some example embodiments, zero-skipping may be used when element-wise multiplications with respect to channels are sequentially performed when a processing element PE performs a dot product on a feature beam and/or a weight beam. Accordingly, when the dot product is performed by the processing element PEa of FIG. 8, the zero-skipping may be used. The processing element PEb of FIG. 13 may be configured to perform channel-wise multiplications concurrently and/or simultaneously with respect to a plurality of channels, and accordingly, it may be more difficult to apply zero-skipping. However, the number of times of storing an addition result in the register 3b during a dot product by the processing element PEb of FIG. 13 may be significantly less than the number of times of storing an addition result in the register 3a during a dot product by the processing element PEa of FIG. 8.

In the case of the dot product by the processing element PEa of FIG. 8, when the number of times of skipping a multiplication with respect to a channel decreases, the number of times of storing an addition result in the register 3a may increase. Accordingly, an increment in power consumption caused by storing addition results in the register 3a may be relatively greater than a decrement in power consumption via zero-skipping. Accordingly, when the proportion of weights having a zero value is less than the reference value, neural network processing circuitry 130a may be configured to determine not to use zero-skipping during a dot product between a feature beam and a weight beam and/or may control the computing circuit 131 so that the dot product is performed in the processing element PEb of FIG. 13. As described in some example embodiments presented herein, a neural network processing circuitry 130a that is configured to use or not use zero-skipping based on the proportion of weights having a zero value may exhibit reduced power consumption in the processing of a convolution operation of a neural network.

In some example embodiments and as shown in FIG. 14, neural network processing circuitry 130a may be configured to determine whether to use zero-skipping based on the proportion of weights having a zero value. However, some example embodiments of some inventive concepts may not be limited to the examples of FIG. 14. For example, in some example embodiments, the neural network processing circuitry 130a may be configured to calculate the proportion of zero feature values in a transformed input feature map and/or may determine whether to use zero-skipping based on the calculated proportion. In some example embodiments, neural network processing circuitry 130a may be configured to determine not to use zero-skipping during a dot product between a feature beam and a weight beam when the proportion of feature values having a zero value is less than a reference value.

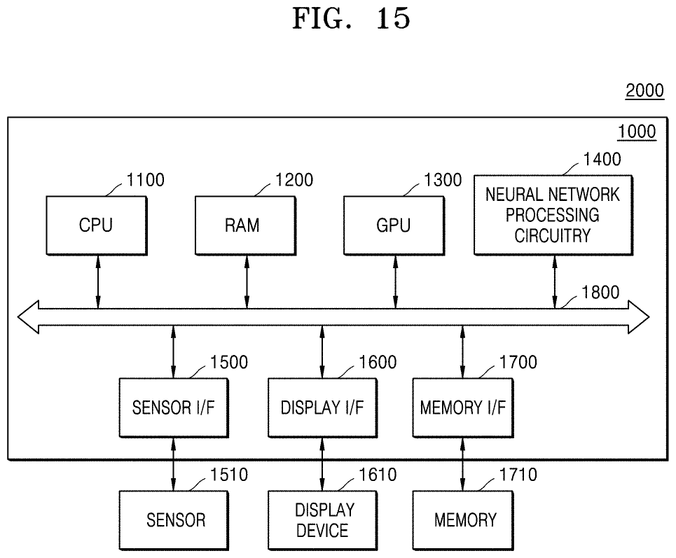

FIG. 15 is a block diagram of an integrated circuit and an apparatus including the same, according to some example embodiments of some inventive concepts. Referring to FIG. 15, an apparatus 2000 may include an integrated circuit 1000 and/or elements, for example, a sensor 1510, a display device 1610, a memory 1710, connected to the integrated circuit 1000. The apparatus 2000 may be configured to process data involving a neural network.

The integrated circuit 1000 may include a CPU 1100, RAM 1200, a GPU 1300, neural network processing circuitry 1400, a sensor interface (I/F) 1500, a display interface 1600, and/or a memory interface 1700. The integrated circuit 1000 may further include other elements such as a communication module, a DSP, and/or a video module. Some or all of the elements of the integrated circuit 1000, such as the CPU 1100, the RAM 1200, the GPU 1300, the neural network processing circuitry 1400, the sensor interface 1500, the display interface 1600, and/or the memory interface 1700, may be configured to exchange data with one another through a bus 1800. In some example embodiments, the integrated circuit 1000 may include an application processor. In some example embodiments, the integrated circuit 1000 may be implemented as a system-on-a-chip (SoC).

In some example embodiments, the CPU 1100 may be configured to control some or all operations of the integrated circuit 1000. The CPU 1100 may include a single core or multiple cores. The CPU 1100 may be configured to process or execute programs and/or data, which are stored in the memory 1710. In some example embodiments, the CPU 1100 may be configured to control the functions of the neural network processing circuitry 1400 by executing the programs stored in the memory 1710.

In some example embodiments, the RAM 1200 may be configured to store programs, data, and/or instructions in a temporary (e.g., volatile) and/or persistent (e.g., nonvolatile) manner. In some example embodiments, the RAM 1200 may include DRAM or SRAM. The RAM 1200 may be configured to store data, such as image data, in a temporary (e.g., volatile) and/or persistent (e.g., nonvolatile) manner. The data stored by the RAM 1200 may be input and/or output through interfaces, such as the sensor interface 1500 and/or the display interface 1600, and/or may be generated in the GPU 1300 or the CPU 1100.

In some example embodiments, the integrated circuit 1000 may further include ROM. The ROM may be configured to store programs and/or data, which may be continuously used. The ROM may include EPROM and/or EEPROM.

In some example embodiments, the GPU 1300 may be configured to perform image processing on image data. For example, the GPU 1300 may be configured to perform image processing on image data that is received through the sensor interface 1500. The image data processed by the GPU 1300 may be stored in the memory 1710 and/or provided to the display device 1610 through the display interface 1600. The image data stored in the memory 1710 may be provided to the neural network processing circuitry 1400.

In some example embodiments, the sensor interface 1500 may be configured to interface data (e.g., image data, audio data, etc.) input from the sensor 1510 connected to the integrated circuit 1000.

In some example embodiments, the display interface 1600 may be configured to interface with data (e.g., an image) output to the display device 1610. The display device 1610 may be configured to output an image or data about the image through a display such as a liquid crystal display (LCD) or an active matrix organic light-emitting diode (AMOLED) display.

In some example embodiments, the memory interface 1700 may be configured to interface with data input from the memory 1710 outside the integrated circuit 1000 and/or data output to the memory 1710. In some example embodiments, the memory 1710 may include volatile memory such as DRAM or SRAM or non-volatile memory such as ReRAM, PRAM, or NAND flash memory. The memory 1710 may be implemented as a memory card such as a multimedia card (MMC), an embedded MMC (eMMC), a secure digital (SD) card, or a micro SD card.

In some example embodiments, neural network processing circuitry 1400 may be configured to perform a convolution operation based on a Winograd transform, such as described herein with reference to one or more of FIGS. 1 through 13. In some example embodiments, neural network processing circuitry 1400 may be configured to perform a convolution operation by performing a Winograd transform on an input feature map and/or a plurality of weight kernels on a convolution layer and/or performing an element-wise multiplication on a transformed input feature map and/or a plurality of transformed weight kernels in a Winograd domain.

In some example embodiments, neural network processing circuitry 1400 may be configured to perform the element-wise multiplication on a transformed input feature map and/or the transformed weight kernels by performing element-wise multiplication with respect to each beam (e.g., a feature beam or a weight beam), which may include corresponding elements throughout a plurality of channels (i.e., feature values or weights on a same position in matrices), and/or to add multiplication results. For example, the neural network processing circuitry 1400 may be configured to perform a dot product on a feature beam of the transformed input feature map and/or a weight beam of each of the transformed weight kernels, and/or to perform dot products between feature beams and weight beams in parallel beam-by-beam (for example, element-by-element in matrices).

In some example embodiments, neural network processing circuitry 1400 may be configured to perform an operation with respect to feature values and/or weights in the channel direction sequentially. For example, neural network processing circuitry 1400 may be configured to skip a multiplication between a feature value and a weight with respect to a channel for which at least one of the feature value and the weight has a zero value. In other words, zero-skipping may be used with respect to a feature value or a weight during the operation of neural network processing circuitry 1400.

In some example embodiments, neural network processing circuitry 1400 may be configured to determine whether or not to use the zero-skipping based on the proportion of features having a zero value in an input feature map or the proportion of weights having a zero value in weight kernels. For example, when the proportion of features having a zero value is less than a reference value, the zero-skipping may not be used.

In some example embodiments, some functions of neural network processing circuitry 1400 may be performed by other components of a neural network device, such as a CPU 1100 or a GPU 1300. At least one of other processes, for example, weight kernel pre-processing (for example, Winograd transform and/or reformatting into weight beams), Winograd transform of an input feature map, reverse reformatting of dot product results, and/or Winograd reverse transform of an output feature map resulting from reverse reformatting in a Winograd domain, than dot products between feature beams and weight beams may be performed by another processor.

According to some example embodiments, neural network processing circuitry 1400 may be configured to perform a convolution operation based on a Winograd transform in a manner that may reduce a number of operations and/or a number and/or capacity of registers. In some example embodiments, the performance of a neural network apparatus 2000, or a portion thereof such as neural network processing circuitry 1400 and/or an integrated circuit 1000, may be enhanced and/or power consumption thereof may be reduced.

As used herein, a description of two or more operations and/or events occurring “concurrently” and “simultaneously” is intended to indicate that during at least one time point, at least a portion of each such operations and/or events is performed. In some example embodiments, such operations or events may occur over an identical duration, such as beginning at the same instant, ending at the same instant, and/or occurring at the same or similar pace over the duration by an identical set of steps. In other example embodiments, such two or more operations or events may only partially overlap; for example, a first operation or event may start at different instants, end at different instants, and/or occur at a different pace over a selected duration by the same or different sets of operations. All such variations that are reasonably and logically possible, and that are not contradictory with other statements, are intended to be included in this disclosure, the scope of which is to be understood as being defined by the claims.

While some inventive concepts have been shown and described with reference to some example embodiments thereof, it will be understood that various changes in form and details may be made therein without departing from the spirit and scope of the following claims. For example, some example embodiments include neural network processing circuitry 130 that is organized as a set of elements or components including a computing circuit 131, a weight buffer 132, a feature map buffer 133, a transform circuit 134, a controller 135, and/or RAM 136. It is to be appreciated that other example embodiments may include fewer (such as one) or additional elements or components; may rename and/or rearrange certain elements or components; may omit or include duplicates of certain elements or components; may organize such elements or components in a different manner, such as combining the computing circuit 131 and the transform circuit 134 into a single circuit; and/or may utilize a variety of technology for each element or component, such as hardware, software, or a combination of hardware and software. Some example embodiments may include multiple components or elements in one device, while other example embodiments may distribute such components or elements in multiple intercommunicating devices. Some example embodiments may include sharing resources, such as a processor or a memory circuit, among several elements or components either in series (such as sequentially) and/or in parallel (such as concurrently), while other example embodiments may include different sets of resources for different elements or components. All such variations that are reasonably and logically possible, and that are not contradictory with other statements, are intended to be included in this disclosure, the scope of which is to be understood as being defined by the claims.

What is claimed is:

1. A device for performing a convolution operation of a neural network, the device comprising:
neural network processing circuitry configured to,
generate a transformed input feature map by performing a Winograd transform on an input feature map, the transformed input feature map including a plurality of channels, each having a matrix form;
perform element-wise multiplications between a feature vector of the transformed input feature map and a weight vector of a transformed weight kernel obtained based on the Winograd transform; and
add results of the element-wise multiplications, the element-wise multiplications being performed channel-by-channel with respect to the feature vector including feature values on a same position in the plurality of channels of the transformed input feature map.

2. The device of claim 1, wherein the neural network processing circuitry is configured to perform the element-wise multiplications channel sequentially and channel-by-channel with respect to input feature values included in the feature vector of the transformed input feature map and weights included in the weight vector of the transformed weight kernel and adds results of the element-wise multiplications, the input feature values and the weights having a non-zero value, and the weight vector corresponding to the feature vector.

3. The device of claim 1, wherein the neural network circuitry is further configured to skip an element-wise multiplication with respect to a channel having at least one of features having a zero value and weights having the zero value, the features being included in the feature vector of the transformed input feature map, and the weights being included in the weight vector of the transformed weight kernel.

4. The device of claim 1, wherein the neural network processing circuitry is further configured to generate information about first input features having a non-zero value in the input feature map.

5. The device of claim 1, wherein the neural network processing circuitry is further configured to reformat the transformed weight kernel into a plurality of weight vectors by grouping weights in corresponding positions in the plurality of channels of the transformed weight kernel into each of the weight vectors.

6. The device of claim 5, wherein the neural network processing circuitry is further configured to generate a transformed output feature map by reverse reformatting output feature values based on a position of a corresponding one of the plurality of weight vectors and configured to perform a Winograd reverse transform on the transformed output feature map.

7. The device of claim 1, wherein the neural network processing circuitry simultaneously performs the element-wise multiplications channel-by-channel with respect to feature values included in the feature vector of the transformed input feature map and weights included in the weight vector of the transformed weight kernel and adds results of the element-wise multiplications.

8. A method of operating a device including neural network processing circuitry for performing a convolution operation of a neural network, the method comprising:
reformatting, by the neural network processing circuitry, at least one Winograd-transformed weight kernel into a plurality of weight beams by grouping weights in corresponding positions in a plurality of channels of the at least one Winograd-transformed weight kernel into each of the weight beams;
obtaining, by the neural network processing circuitry, a Winograd-transformed input feature map;
performing, by the neural network processing circuitry, a dot product on each of a plurality of feature beams and a corresponding weight beam among the plurality of weight beams, each of the plurality of feature beams including feature values on a same position in the plurality of channels of the Winograd-transformed input feature map;
generating, by the neural network processing circuitry, an output feature map by reverse reformatting dot product results based on respective positions of the plurality of weight beams, the dot product results being respectively calculated with respect to the plurality of weight beams; and
performing, by the neural network processing circuitry, a Winograd reverse transform on the output feature map.

9. The method of claim 8, wherein the performing of the dot product comprises:
sequentially performing, by the neural network processing circuitry, element-wise multiplications channel-by-channel on feature values of a first feature beam among the plurality of feature beams and weights of a first weight beam among the plurality of weight beams; and
adding, by the neural network processing circuitry, sequentially generated multiplication results.

10-11. (canceled)

12. The method of claim 9, wherein performing the element-wise multiplications comprises performing, by the neural network processing circuitry, an element-wise multiplication channel-by-channel on at least one feature value having a zero value among the feature values of the first feature beam and at least one weight having a non-zero value among the weights of the first weight beam.

13. The method of claim 8, wherein obtaining the Winograd-transformed input feature map comprises generating, by the neural network processing circuitry, at least one of information about input feature values having a non-zero value in the Winograd-transformed input feature map and information about weights having a non-zero value in the at least one Winograd-transformed weight kernel.

14. (canceled)

15. The method of claim 8, wherein performing the dot product comprises performing in parallel, by the neural network processing circuitry, dot products for the plurality of feature beams.

16-18. (canceled)

19. The method of claim 8, further comprising determining, by the neural network processing circuitry, at least one of a proportion of zero values among the feature values and a proportion of zero values among the weights,
wherein, when the proportion of zero values is equal to or greater than a reference value, performing the dot product comprises,
performing sequentially, by the neural network processing circuitry, element-wise multiplications channel-by-channel on feature values of a first feature beam and weights of a first weight beam;
adding sequentially, by the neural network processing circuitry, multiplication results of the element-wise multiplications; and
skipping an element-wise multiplication with respect to a channel having at least one of a feature value having a zero value and a weight having a zero value, and
when the proportion of zero values is less than the reference value, the performing of the dot product comprises simultaneously performing element-wise multiplications channel-by-channel on the feature values of the first feature beam and the weights of the first weight beam and adding the multiplication results.

20. A neural network device comprising:
neural network processing circuitry configured to perform a neural network operation by,
performing a Winograd-based convolution operation by performing an element-wise dot product on a input feature map and weight kernels obtained via Winograd transform, respectively, and
performing the element-wise dot product with respect to each feature beam including corresponding elements in a plurality of channels of the input feature map.

21. The neural network device of claim 20, wherein
the neural network processing circuitry includes a plurality of processing elements each configured to perform the element-wise dot product with respect to each feature vector including feature values on a same position in the plurality of channels of the input feature map, and
the neural network processing circuitry is further configured to,
generate the input feature map using the Winograd transform,
generate a transformed output feature map by reverse reformatting output features based on a position of a corresponding weight vector among a plurality of weight vectors, and
perform Winograd reverse transform on the transformed output feature map.

22. The neural network device of claim 21, wherein each of the plurality of processing elements is configured to perform, sequentially, multiplications channel-by-channel with respect to input feature values included in the feature vector of the input feature map and weights included in a weight vector of each of the weight kernels and adds results of the multiplications, the input feature values and the weights having a non-zero value, and the weight vector corresponding to the feature vector.

23. The neural network device of claim 21, wherein each of the plurality of processing elements is configured to skip a multiplication with respect to a channel having at least one of features having a zero value and weights having the zero value, the features being included in the feature vector of the input feature map, and the weights being included in a weight vector of each of the weight kernels.

24. The neural network device of claim 20, wherein the neural network processing circuitry is further configured to perform the Winograd transform on the weight kernels.

25. The neural network device of claim 24, wherein the neural network processing circuitry is further configured to reformat each of the weight kernels into a plurality of weight vectors by grouping weights in corresponding positions in the plurality of channels of the weight kernels into each of the weight vectors.

26. The device of claim 1, wherein,
the neural network further comprises a classifier that identifies a classification of an input, and
the neural network processing circuitry is further configured to,
receive an input as a set of input activations, and
perform the convolution operation of the neural network on the set of input activations to generate a classification of the input based on the convolution operation.
